(19) United States
(12) Patent Application Publication
(10) Pub. No.: US 2011/0090968 A1
(43) Pub. Date: Apr. 21, 2011

(54) Low-Cost Video Encoder

(75) Inventor: Yuguo YE, Santa Clara, CA (US)

(73) Assignee: OmniVision Technologies, Inc., Santa Clara, CA (US)

(21) Appl. No.: 12/905,924

(22) Filed: Oct. 15, 2010

Related U.S. Application Data
(60) Provisional application No. 61/251,857, filed on Oct. 15, 2009.

(51) Int. Cl. H04N 7/26

(52) U.S. Cl. 375/240.24; 375/E07.2

(57) ABSTRACT

A method for encoding a new unit of video data includes: (1) incrementally, in raster order, decoding blocks within a search window of a unit of encoded reference video data into a reference window buffer, and (2) encoding, in raster order, each block of the new unit of video data based upon a decoded block of the reference window buffer. A system for encoding a new unit of video data includes a reference window buffer, a decoding subsystem, and an encoding subsystem. The decoding subsystem is configured to incrementally decode, in raster order, blocks within a search window of a unit of encoded reference video data into the reference window buffer. The encoding subsystem is configured to encode, in raster order, each block of the new unit of video data based upon a decoded block of the reference window buffer.

### CROSS-REFERENCE TO RELATED APPLICATIONS

This application claims benefit of priority to U.S. Provisional Patent Application Ser. No. 61/251,857 filed Oct. 15, 2009, which is incorporated herein by reference.

### BACKGROUND

Digital video coding technology enables the efficient storage and transmission of the vast amounts of visual data that compose a digital video sequence. With the development of international digital video coding standards, digital video has now become commonplace in a host of applications, ranging from video conferencing and DVDs to digital TV, mobile video, and Internet video streaming and sharing. Digital video coding standards provide the interoperability and flexibility needed to fuel the growth of digital video applications worldwide.

There are two international organizations currently responsible for developing and implementing digital video coding standards: the Video Coding Experts Group (“VCEG”) and the Moving Pictures Experts Group (“MPEG”). VCEG has developed the H.26x (e.g., H.261, H.263) family of video coding standards and the MPEG has developed the MPEG-x (e.g., MPEG-I, MPEG-4) family of video coding standards. The H.26x standards have been designed mainly for real-time video communication applications, such as video conferencing and video telephony, while the MPEG standards have been designed to address the needs of video storage, video broadcasting, and video streaming applications.

The ITU-T and the ISO/IEC have also joined efforts in developing high performance, high-quality video coding standards, including the previous H.262 (or MPEG-2) and the recent H.264 (or MPEG-4 Part 10/AVC) standard. The H.264 video coding standard, adopted in 2003, provides high video quality at substantially lower bit rates than previous video coding standards. The H.264 standard provides enough flexibility to be applied to a wide variety of applications, including low and high bit rate applications as well as low and high resolution applications.

The H.264 encoder divides each video frame of a digital video sequence into 16×16 blocks of pixels, called “macroblocks”. Each macroblock is either “intra-coded” or “inter-coded”.

Intra-coded macroblocks are compressed by exploiting spatial redundancies that exist within the macroblock through transform, quantization and entropy (e.g. variable-length) coding. To further increase coding efficiency, spatial correlation between the intra-coded macroblock and its adjacent macroblocks may be exploited by using intra-prediction, where the intra-coded macroblock is first predicted from the adjacent macroblocks and then only the difference from the predicted macroblock is coded.

Inter-coded macroblocks, on the other hand, exploit temporal redundancies—similarities across different frames. In a typical video sequence, consecutive frames are often similar to one another, with only minor pixel movements from frame to frame, usually caused by the motion of the object or the camera. Consequently, for all inter-coded macroblocks, the H.264 encoder performs motion estimation and motion compensation. During the motion estimation, the H.264 encoder searches for the best matching 16×16 block of pixels in another frame, hereinafter referred to as “the reference frame”. In practical applications, the search is typically restricted to a confined “search window” centered on the current macroblock position. At the motion compensation stage, the obtained best matching 16×16 block of pixels is subtracted from the current macroblock to produce a residual block that is then encoded and transmitted together with a “motion vector” that describes the relative position of the best matching block. It will be noted, that according to the H.264 standard, the H.264 encoder may choose to split the 16×16 inter-coded macroblock into partitions of various sizes, such as 16×8, 8×16, 8×8, 4×8, 8×4 and 4×4, and have each partitions independently motion-estimated, motion-compensated and coded with its own motion-vector. However, for the purpose of brevity and without limiting generality, the examples described in this disclosure only refer to single partition inter-macroblocks.

Like many other video coding standards, the H.264 standard distinguishes between three main types of frames: I-Frames, P-Frames and B-Frames. I-Frames may contain only intra-coded macroblocks. P-Frames may only contain intra-coded macroblocks and/or inter-coded macroblocks motion-compensated from a past reference frame. B-Frames may contain intra-coded macroblocks and/or inter-coded macroblocks motion-compensated from a past frame, from a future frame or from a linear combination of the two. Different standards may have different restrictions as to which frames can be chosen as reference frames for a given frame. In the MPEG-4 Visual standard, for example, only the nearest past or future P or I frames can be designated as the reference frames for the current frame. The H.264 standard does not have this limitation, and allows for more distant frames to serve as reference frames for the current frame.

In FIG. 1, an exemplary embodiment of a typical H.264 encoder system 100 is schematically shown. A current frame 105 is processed in units of a macroblock 110 (represented by an arrow). Macroblock 110 is encoded in either intra or inter mode as indicated by a prediction mode 119 (represented by an arrow) and for each macroblock a prediction block 125 (represented by an arrow) is formed. In intra mode, an intra-prediction block 118 (represented by an arrow) is formed by an intra prediction module 180 based on adjacent macroblocks data 166 (represented by an arrow) stored in the intra-prediction buffer 165. In inter mode, an ME/MC module 115 performs motion estimation and outputs a motion-compensated prediction block 117 (represented by an arrow). Depending on prediction mode 119, a mux 120 passes through either intra-prediction block 118 or motion-compensated prediction block 117, and the resulting prediction block 125 is then subtracted from macroblock 110. A residual block 130 (represented by an arrow) is transformed and quantized by a DCT/Q module 135 to produce a quantized block 140 (represented by an arrow) that is then encoded by an entropy encoder 145 and passed to a bitstream buffer 150 for transmission and/or storage.

Still referring to FIG. 1, in addition to encoding and transmitting a macroblock, the encoder decodes (“reconstructs”) it to provide a reference for future intra- or inter-predictions. Quantized block 140 is inverse-transformed and inverse-quantized by an IDCT/InvQ module 155 and added back to prediction block 125 to form a reconstructed block 160 (represented by an arrow). Reconstructed block 160 is then written into an intra prediction buffer 165 to be used for intra-prediction for future macroblocks. Reconstructed block 160 is also passed through a deblocking filter 170 that may reduce unwanted compression artifacts and is finally stored in its corresponding position in an uncompressed reference frames buffer 175. It will be noted that since deblocking filtering is optional in the H.264 standard, some systems may not include deblocking filter 170 and store reconstructed block 160 directly into uncompressed reference frames buffer 175.

### SUMMARY

In an embodiment, a method for encoding a new unit of video data includes: (1) incrementally, in raster order, decoding blocks within a search window of a unit of encoded reference video data into a reference window buffer, and (2) encoding, in raster order, each block of the new unit of video data based upon a decoded block of the reference window buffer.

In an embodiment, a system for encoding a new unit of video data includes a reference window buffer, a decoding subsystem, and an encoding subsystem. The decoding subsystem is configured to incrementally decode, in raster order, blocks within a search window of a unit of encoded reference video data into the reference window buffer. The encoding subsystem is configured to encode, in raster order, each block of the new unit of video data based upon a decoded block of the reference window buffer.

### BRIEF DESCRIPTION OF THE DRAWINGS

The present disclosure may be understood by reference to the following detailed description taken in conjunction with the drawings briefly described below. It is noted that, for purposes of illustrative clarity, certain elements in the drawings may not be drawn to scale.

FIG. 1 is a block diagram illustrating a prior art H.264 video encoder system.

FIG. 2 is a block diagram illustrating a frame reference scheme, in accordance with an embodiment.

FIG. 3 is a block diagram illustrating an H.264 video encoder system, in accordance with an embodiment.

FIG. 4 is a block diagram illustrating a process of a partial decoding of a reference frame, in accordance with an embodiment.

FIG. 5 is a time diagram further illustrating the partial decoding process of FIG. 4, in accordance with an embodiment.

FIG. 6 is a block diagram illustrating another frame reference scheme, in accordance with an embodiment.

FIG. 7 is a block diagram illustrating another H.264 video encoder system, in accordance with an embodiment.

FIG. 8 is a block diagram illustrating another process of a partial decoding of a reference frame, in accordance with an embodiment.

FIG. 9 is a time diagram further illustrating the partial decoding process of FIG. 8, in accordance with an embodiment.

FIG. 10 shows a method for encoding a new unit of video data, in accordance with an embodiment.

### DETAILED DESCRIPTION OF ILLUSTRATED EMBODIMENTS

The following embodiments and aspects thereof are described and illustrated in conjunction with systems, tools and methods, which are meant to be exemplary and illustrative, not limiting in scope. In various embodiments, one or more limitations associated with the above-described systems and methods have been addressed, while other embodiments are directed to other improvements.

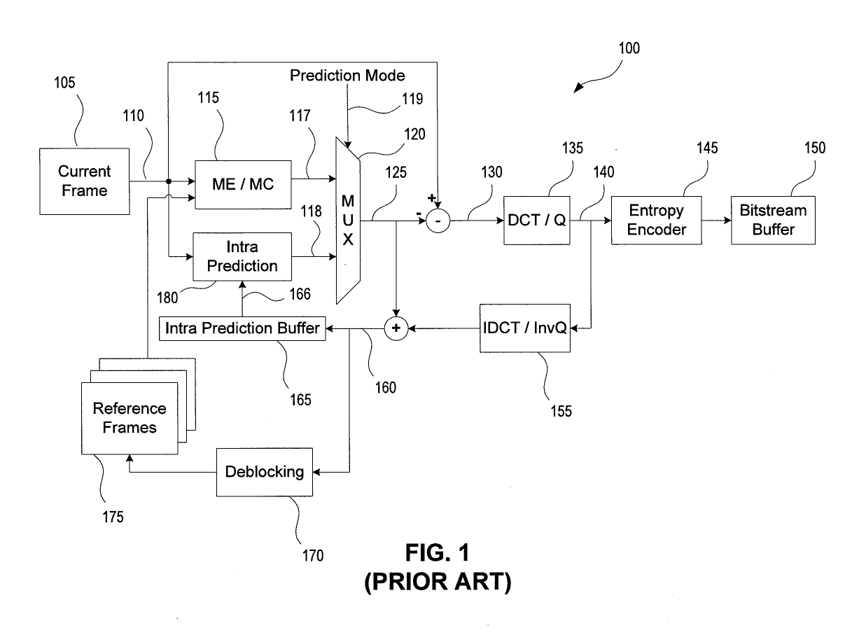

One important characteristic of the H.264 encoder design is the memory size and memory bandwidth that it requires. The typical H.264 encoder system 100 described in FIG. 1 requires at least the following memory buffers: intra prediction buffer 165, a buffer for current frame 105, and uncompressed reference frames buffer 175. Intra prediction buffer 165 is relatively small, as only several adjacent macroblocks are necessary for intra prediction. Current frame 105 does not have to be stored in its entirety. For example, if “ping-pong” buffers are used, only two lines of macroblocks are required: while one line of macroblocks is being processed, the second line of macroblocks is populated with new pixel data, and once the first line is fully processed, they switch roles. Even more memory could be saved by implementing more advanced memory management techniques.

Still referring to FIG. 1, in contrast to the two aforementioned memory buffers, uncompressed reference frames buffer 175 contains full, non-coded (“uncompressed”) frames. One uncompressed VGA (640×480) frame may require as much as 460KB of memory and the buffer will normally contain at least two uncompressed frames: one that is being referenced and one that is being encoded, reconstructed and saved for future reference. Moreover, if B-Frames are used, each B-Frame will have to be temporarily stored, uncompressed, until its future reference frame is encoded and reconstructed.

The excessive demand for memory translates into increased system cost: to support the H.264 encoder, the system has to provide it with sufficient memory space and memory bandwidth. The latter is a significant factor, because even systems that might have dispensable memory space will often require additional circuitry in order to guarantee memory access rate high enough to accommodate the H.264 encoder (operating at its maximum data rate) and all other clients sharing the memory.

Memory space and bandwidth are especially limited in small portable applications such as cell phones, camcorders or digital cameras, because those are highly sensitive to power consumption, and power consumption grows with increased memory access rate. As a result, many single-chip applications that would not otherwise require an external memory chip are forced to include one, only to support the H.264 encoder. This will not only affect the overall cost, but also increase the footprint of the application, something portable application manufacturers try to avoid.

Accordingly, it would be desirable to provide an H.264 encoder system and method that would drastically reduce the amount of the required memory, thus avoiding the need for an external memory chip, improving the overall system performance and reducing its cost.

As mentioned earlier, the H.264 standard is very flexible in respect to assigning different frame types (i.e., I-Frame, P-Frame or B-Frame) to different frames and, in case of P-Frames or B-Frames, in selection of their respective reference frames.

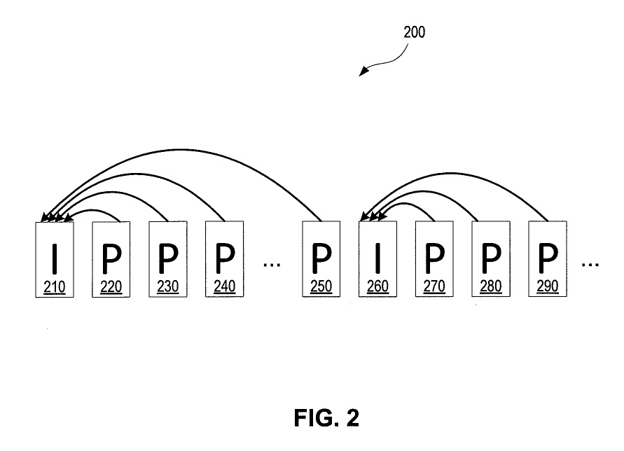

FIG. 2 illustrates a type assignment and reference scheme 200 in accordance with an embodiment. Each frame is assigned to be either an I-Frame or a P-Frame, and there are no B-Frames. Every P-Frame references the I-Frame that precedes it in display order. For example, P-Frames 220, 230, 240, and 250 use I-Frame 210 as their reference frame, and P-Frames 270, 280 and 290 use I-Frame 260 as their reference frame. It will be appreciated that the number of P-Frames between two consecutive I-Frames can be arbitrary and that the number does not have to remain constant throughout the video stream.

According to an embodiment, the H.264 encoder does not store or rely on full uncompressed reference frames. Instead, reference data that is required for motion estimation and compensation is obtained by gradually decoding the corresponding reference I-Frame that is stored encoded (“compressed”) in the bitstream buffer. For example, in certain embodiments, only blocks (e.g., macroblocks) within a search window of encoded reference video data (e.g., an encoded reference frame such as a reference I-Frame) are decoded.

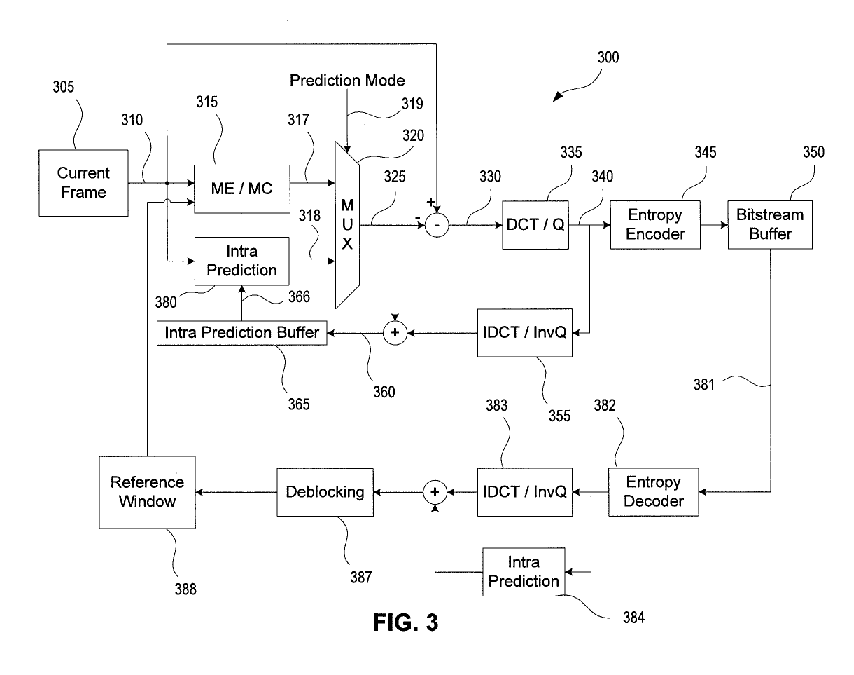

In FIG. 3, an exemplary H.264 encoder system 300, in accordance with the embodiment, is described. A current frame 305 is processed in units of a macroblock 310 (represented by an arrow). Macroblock 310 is encoded in either intra or inter mode as indicated by a prediction mode 319 (represented by an arrow) and for each macroblock a prediction block 325 (represented by an arrow) is formed. In intra mode, an intra-prediction block 318 (represented by an arrow) is formed by an intra prediction module 380 based on adjacent macroblocks data 366 (represented by an arrow) stored in the intra-prediction buffer 365. In inter mode, an ME/MC module 315 performs motion estimation and outputs a motion-compensated prediction block 317 (represented by an arrow). Depending on prediction mode 319, a mux 320 passes through either intra-prediction block 318 or motion-compensated prediction block 317, and the resulting prediction block 325 is then subtracted from macroblock 310. A residual block 330 (represented by an arrow) is transformed and quantized by a DCT/Q module 335 to produce a quantized block 340 (represented by an arrow) that is then encoded by an entropy encoder 345 and passed to a bitstream buffer 350 for transmission and/or storage. Accordingly, ME/MC module 315, intra prediction module 380, mux 320, DCT/Q module 335, and entropy encoder 345 may be considered to collectively form an encoding subsystem. It is anticipated that alternate embodiments of encoder system 300 will have different encoding subsystem configurations. For example, in an alternate embodiment, entropy encoder 345 is replaced with a different type of encoder.

Still referring to FIG. 3, in addition to encoding and transmitting a macroblock, H.264 encoder system 300 decodes (“reconstructs”) it to provide a reference for future intra- or inter-predictions. Quantized block 340 is inverse-transformed and inverse-quantized by an IDCT/InvQ module 355 and added back to prediction block 325 to form a reconstructed block 360 (represented by an arrow). Reconstructed block 360 is then written into an intra prediction buffer 365 to be used for intra-prediction for future macroblocks.

Still referring to FIG. 3, the reference I-Frame data is obtained by reading the encoded I-Frame from the bitstream buffer 350 in units of a macroblock 381 (represented by an arrow). Each macroblock 381 is decoded by an entropy decoder 382, inverse-transformed and inverse-quantized by an IDCT/InvQ module 383 and added to the output of an intra prediction module 384. It is then filtered by a deblocking filter 387 to reduce unwanted compression artifacts and is finally stored in its corresponding position inside an uncompressed reference window buffer 388. Accordingly, entropy decoder 382, IDCT/InvQ module 383, intra prediction module 384, and deblocking filter 387 may be considered to collectively form a decoding subsystem, the configuration of which may vary among different embodiments of encoder system 300. It will be noted that since deblocking filtering is optional in the H.264 standard, some embodiments may choose to bypass deblocking filter 387. In addition, for the purpose of brevity, the intra prediction circuitry in the intra decoding path is simplified and reduced to intra prediction module 384, omitting the standard intra prediction feedback loop from the drawing. It will be also noted that in applications that include both an H.264 encoder and an H.264 decoder on the same chip or board, the H.264 encoder may be able to reuse some of the circuitry of the H.264 decoder, such as the intra-decoding path described above. Thus, it is anticipated that in certain embodiments, some or all of the components of encoder system 300 will be part of a common integrated circuit chip.

It is not necessary to store the entire reference I-Frame in a reference window buffer 388, but only a portion of the reference I-Frame that corresponds to the search window defined by an H.264 encoder system 300—the only area in which the ME/MC module 315 will be searching for the best matching reference block. Because in most practical implementations the search window constitutes only a small portion of the entire frame, reference window buffer 388 is usually relatively small and can be stored internally, on the same chip. Thus, in certain embodiments, reference window buffer 388 is smaller than the reference I-Frame.

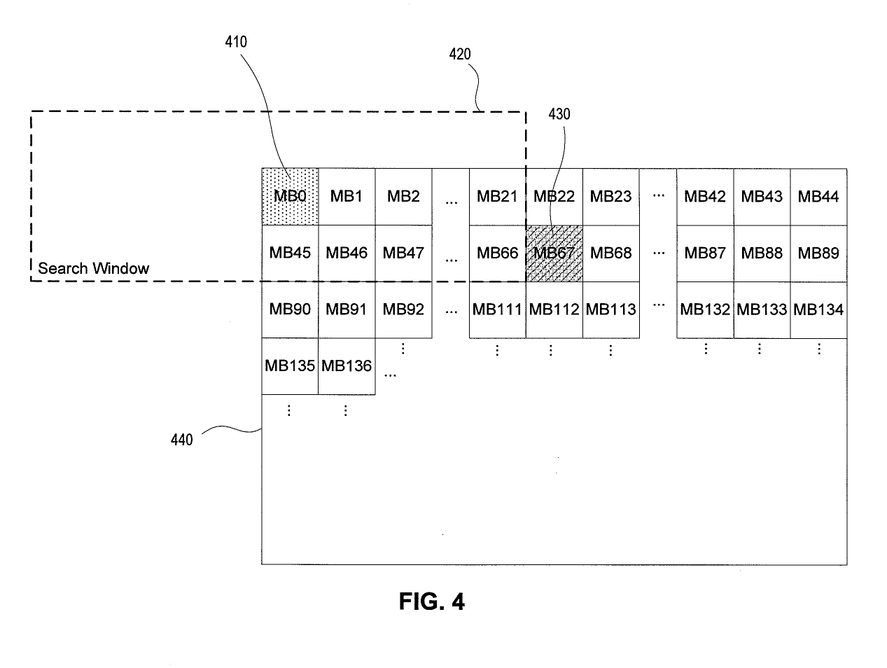

FIG. 4 schematically illustrates how a reference frame can be gradually decoded, in accordance with an embodiment. In this example, a current frame 440 is 45 macroblocks wide and a search window 420 is defined to be 44×3 macroblocks with its center aligned to the macroblock that is currently processed. This means that to process an inter-coded macroblock in currently encoded frame 440, a 44×3 macroblock window from the reference I-Frame has to be readily decoded and available in the reference window buffer. For example, to encode the first macroblock MB0 410 (of the P-Frame) a support of macroblocks MB0-MB22 and MB45-MB66 (of the reference I-Frame) is required. Similarly, encoding MB67 430 (of the P-Frame) requires a support of MB1-MB44, MB46-MB89 and MB91-MB134 (of the reference I-Frame). It will be noted that if the position of the processed macroblock is such that the supporting window exceeds the boundaries of the frame, that excessive portion, obviously, cannot and need not be decoded.

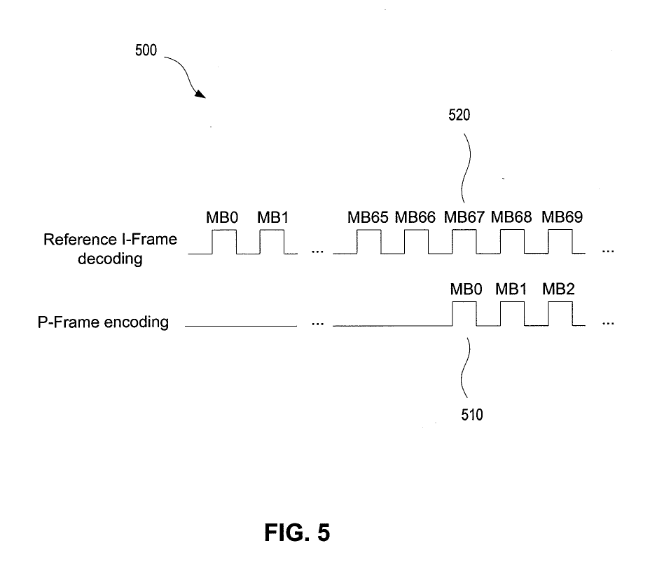

FIG. 5 provides an exemplary time diagram 500 that describes the simultaneous P-Frame encoding and reference I-Frame decoding, in accordance with an embodiment. First, macroblocks MB0 to MB66 of the reference I-Frame are decoded and stored into the reference window buffer. That provides enough reference data support for the first macroblock (MB0 510) of the P-Frame to be encoded. While MB0 510 of the P-Frame is being encoded, MB67 520 of the reference I-Frame is being decoded and stored into the reference window buffer. Next, MB1 of the P-Frame is encoded and MB68 of the reference I-Frame is decoded and stored, and the process goes on in this manner, following raster order, until the last macroblock in P-Frame is encoded (I-Frame decoding ends earlier, when its last macroblock is decoded). Thus, reference I-Frame decoding begins and ends earlier than P-Frame encoding.

For efficient memory usage, the newly decoded I-Frame macroblock can overwrite the “oldest” I-Frame macroblock in the reference window buffer, the macroblock that will no longer be used for reference. For example, in the embodiment described in FIG. 4, MB135 can replace MB0, MB136 can then overwrite MB1, and so on. This mechanism can be implemented through cyclic buffer management. Thus, in some embodiments, macroblocks that do not have a corresponding encoded block within a search window are discarded from reference window buffer 388.

In the example above, the size of the reference window buffer slightly exceeds the size of the search window. This is because the decoded macroblocks are processed in raster order, which is by far the easiest way to decode an I-Frame. It will be appreciated, however, that there are more complex decoding sequences that can bring the reference window buffer size down to the search window size.

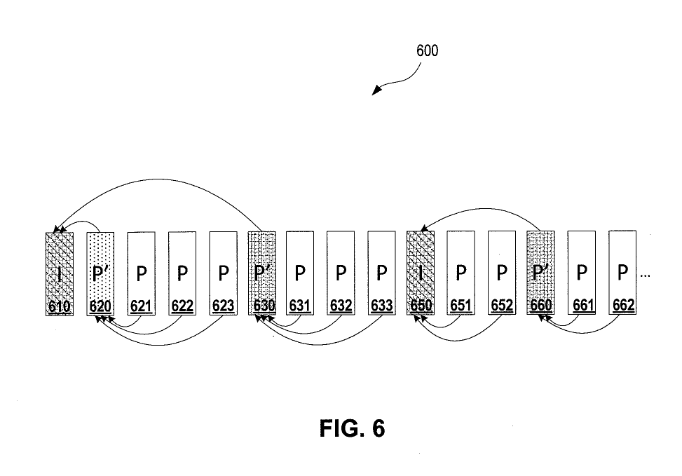

According to another embodiment, the H.264 video encoder employs I-Frames and P-Frames only. Some P-Frames, hereinafter referred to as P′-Frames, will serve as references to other P-Frames. Other P-Frames will reference the preceding P′-Frame or I-Frame, whichever is closer. One example of this reference scheme is illustrated in FIG. 6. It will be appreciated that the number of P-Frames between two consecutive reference frames (P′ or I) and the number of P′ Frames between I-Frames can be arbitrary and that these numbers do not have to remain constant throughout the video stream. It will also be appreciated that I-Frame does not have to be followed by a P′-Frame; it may, instead, be followed by one or more P-Frames.

FIG. 6 illustrates a type assignment and reference scheme 600 in accordance with another embodiment. Each frame is assigned to be either an I-Frame or a P-Frame, and there are no B-Frames. Some P-Frames, hereinafter referred to as P′-Frames, will serve as references to other P-Frames. Other P-Frames will reference the preceding P′-Frame or I-Frame, whichever is closer. In the example illustrated in FIG. 6, as indicated by the arrows, P′-Frames 620 and 630 use I-Frame 610 as their reference frame, and P-Frames 621, 622, 623 and 631, 632, 633 use P′-Frames 620 and 630 as their reference frames, respectively. In the next group of frames, however, the reference scheme could be slightly different, as illustrated by this example: P-Frames 651 and 652 use I-Frame 650 as their reference and P-Frames 661 and 662 use P′-Frame 660 as their reference. It will be appreciated that the number of P-Frames between two consecutive reference frames (P′ or I) and the number of P′ Frames between I-Frames can be arbitrary and that these numbers do not have to remain constant throughout the video stream. It will also be appreciated that I-Frame does not have to be followed by a P′-Frame; it may, instead, be followed by one or more P-Frames, as illustrated above.

In this embodiment, the H.264 video encoder does not store or rely on full uncompressed reference frames. Instead, reference data that is required for motion estimation and compensation is obtained by gradually decoding the reference frame (I-Frame or P′-Frame) that is stored encoded (compressed) in the bitstream buffer. When P′-Frame is the reference frame, in order to decode it, its own reference (which has to be an I-Frame) must first be at least partially decoded. In this case, both the P′-Frame and the I-Frame are gradually decoded to provide reference data for the encoder.

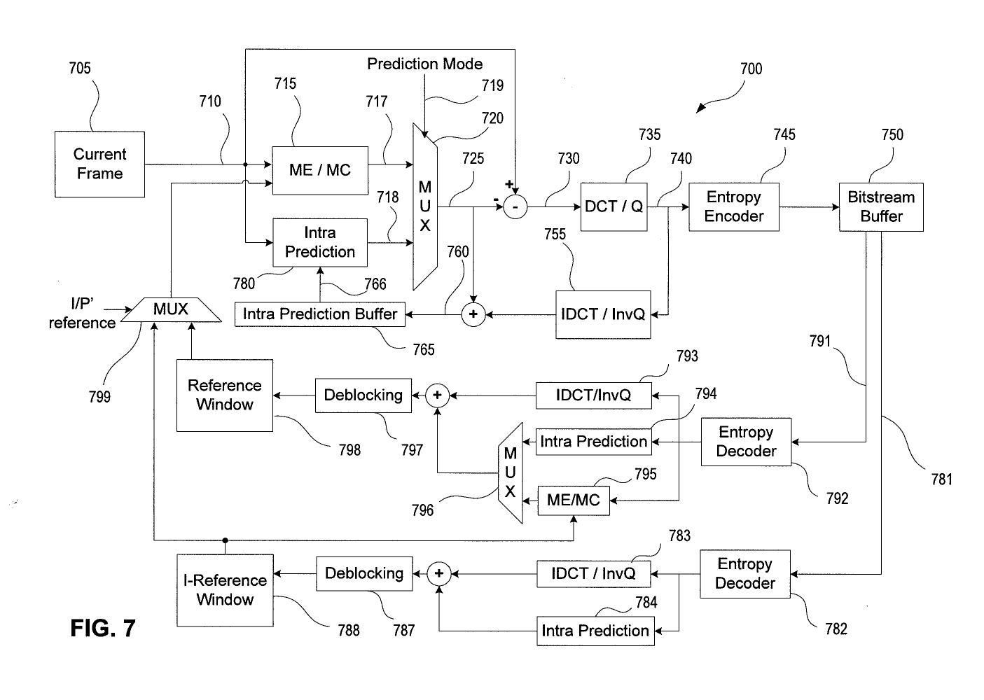

In FIG. 7, an exemplary H.264 encoder system 700, in accordance with the embodiment, is described. A current frame 705 is processed in units of a macroblock 710 (represented by an arrow). Macroblock 710 is encoded in either intra or inter mode as indicated by a prediction mode 719 (represented by an arrow) and for each macroblock a prediction block 725 (represented by an arrow) is formed. In intra mode, an intra-prediction block 718 (represented by an arrow) is formed by an intra prediction module 780 based on adjacent macroblocks data 766 (represented by an arrow) stored in the intra-prediction buffer 765. In inter mode, an ME/MC module 715 performs motion estimation and outputs a motion-compensated prediction block 717 (represented by an arrow). Depending on prediction mode 719, a mux 720 passes through either intra-prediction block 718 or motion-compensated prediction block 717, and the resulting prediction block 725 is then subtracted from macroblock 710. A residual block 730 (represented by an arrow) is transformed and quantized by a DCT/Q module 735 to produce a quantized block 740 (represented by an arrow) that is then encoded by an entropy encoder 745 and passed to a bitstream buffer 750 for transmission and/or storage. Accordingly, ME/MC module 715, intra prediction module 780, mux 720, DCT/Q module 735, and entropy encoder 745 may be considered to collectively form an encoding subsystem. It is anticipated that alternate embodiments of encoder system 700 will have different encoding subsystem configurations. For example, in an alternate embodiment, entropy encoder 745 is replaced with another type of encoder.

Still referring to FIG. 7, in addition to encoding and transmitting a macroblock, H.264 encoder system 700 decodes (“reconstructs”) it to provide a reference for future intra- or inter-predictions. Quantized block 740 is inverse-transformed and inverse-quantized by an IDCT/InvQ module 755 and added back to prediction block 725 to form a reconstructed block 760 (represented by an arrow). Reconstructed block 760 is then written into an intra prediction buffer 765 to be used for intra-prediction for future macroblocks.

Still referring to FIG. 7, current frame 705 may use either I-Frame or P′-Frame as a reference. In both cases, I-Frame reference data is first obtained by reading it from a bitstream buffer 750 in units of a macroblock 781; each macroblock 781 is decoded by an entropy decoder 782, inverse-transformed and inverse-quantized by an IDCT/InvQ module 783 and added to the output of an intra prediction module 784. It is then filtered by a deblocking filter 787 to reduce unwanted compression artifacts and is finally stored in its corresponding position inside an uncompressed I-reference window buffer 788. As previously mentioned, it is not necessary to store the entire reference I-Frame in the I-reference window buffer 788, but only a portion of the frame that corresponds to the search window defined by H.264 encoder system 700.

Referring to FIG. 7 again, when an I-Frame is used as a reference by current frame 705, the data available in I-reference window buffer 788 is simply passed by a mux 799 to ME/MC module 715. However, when a P′-Frame is used as a reference by current frame 705, the data in I-reference window buffer 788 is used to decode the reference P′-Frame—it is passed to a ME/MC module 795 to be used when decoding inter-coded macroblocks of the reference P′-Frame, as illustrated in the following paragraph.

When current frame 705 references a P′-Frame, the P′-Frame encoded data is first obtained from a bitstream buffer 750 in units of a macroblock 791; each macroblock 791 is decoded by an entropy decoder 792, inverse-transformed and inverse-quantized by an IDCT/InvQ module 793 and added to the output of a mux 796 that passes the output of either an intra prediction module 794 or an ME/MC module 795 (that gets its reference data from I-reference window buffer 788), depending on the coding mode of the currently decoded P′-Frame macroblock 791. The macroblock is then filtered by a deblocking filter 797 and is finally stored in its corresponding position inside the uncompressed P′-reference window buffer 798. The data in P′-reference window buffer 798 is passed by mux 799 to ME/MC module 715 that would use it to encode current macroblock 710. Accordingly, entropy decoders 782 and 792, IDCT/InvQ modules 783 and 793, intra prediction modules 784 and 794, deblocking filters 787 and 797, and ME/MC module 795 may be considered to collectively form a decoding subsystem, the configuration of which may vary among different embodiments of encoder system 700. It will be noted that since deblocking filtering is optional in the H.264 standard, some embodiments may choose to bypass deblocking filter 787 and/or deblocking filter 797. It will also be noted that for the purpose of brevity, the intra prediction circuitries in both decoding paths are simplified and reduced to intra prediction modules 794 and 784, omitting the standard intra prediction feedback loops from the drawings. It is anticipated that in certain embodiments, some or all of the components of encoder system 700 will be part of a common integrated circuit chip.

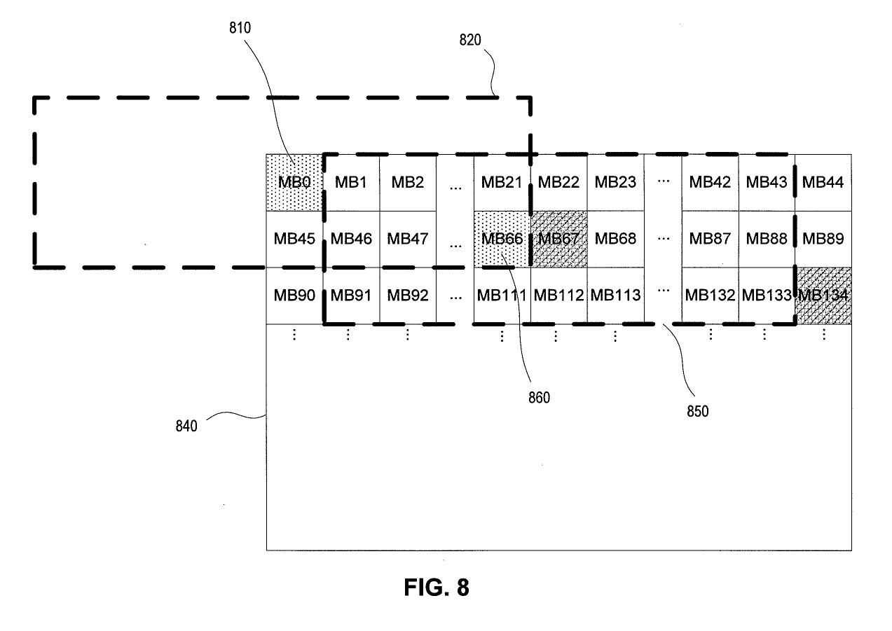

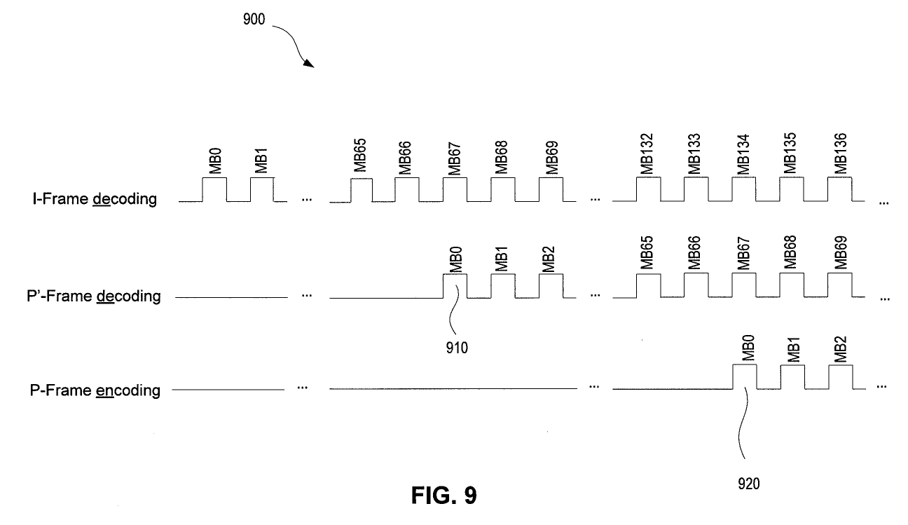

Referring to exemplary H.264 encoder system 700, the process and the time diagram of encoding frames that reference I-Frame is like that of exemplary H.264 encoder system 300 and was fully described in FIG. 4 and FIG. 5. The process and the time diagram of encoding frames that reference P′-Frame is illustrated in FIG. 8 and FIG. 9.

FIG. 8 schematically illustrates how a reference P′-Frame can be gradually decoded, in accordance with an embodiment. In this example, a current frame 840 is 45 macroblocks wide and a search window is defined to be 44×3 macroblocks with its center aligned to the macroblock that is currently processed. A first search window 820 indicates the location of the P′-Frame reference data required to encode MB0 810 of current frame 840. In raster order, the last macroblock in first search window 820 is MB66 860 (of the reference P′-Frame). Decoding that macroblock requires, in turn, the support of a second search window 850 inside the I-Frame that is referenced by the reference P′-Frame. In raster order, the last macroblock in second search window 850 is MB133 (of the I-Frame that is referenced by the reference P′-Frame).

FIG. 9 provides an exemplary time diagram 900 that describes the simultaneous P-Frame encoding, reference P′-Frame decoding and its reference I-Frame decoding, in accordance with an embodiment. First, macroblocks MB0 to MB66 of the I-Frame are decoded and stored into the I-reference window buffer. That provides enough reference data support for the first macroblock (MB0 910) of P′-Frame to be decoded. Therefore, starting next macroblock cycle, P′-Frame macroblocks begin decoding, one after another, in raster order, while I-Frame decoding continues. Once MB0 to MB66 of the P′-Frame are decoded and stored into the P′-reference window buffer, there is enough reference data to start encoding the first macroblock (MB0 920) of the current P-Frame. The process then goes on, simultaneously decoding I- and P′-Frame and encoding the current P-Frame until the current P-Frame is fully encoded (P′-Frame decoding and I-Frame decoding end earlier). Thus, decoding of the I-Frame and the P′-Frame begins and ends earlier than encoding of the P-Frame.

As described earlier, for efficient memory usage, a cyclic buffer management could be implemented for both I-reference and P′-reference window buffers and more complex decoding sequences can bring the reference window buffer size further down.

While the examples described in this disclosure relate to video encoding in accordance with the H.264 video coding standard, it will be appreciated by skilled in the art that the processes described and claimed herein may be applied to other video coding standards that employ similarly flexible reference frame schemes, such as the VC-1 standard, formally known as the SMPTE 421 M video codec standard. It will also be appreciated that although the examples in this disclosure are directed at various hardware implementations of the video encoder, the techniques described and claimed herein may also be applied to purely software implementations or to implementations that combine software and hardware elements to build the video codec.

Additionally, although the methods and systems disclosed herein are generally described with respect to video frames and macroblocks, it should be appreciated that such systems and methods may be adapted for use with other units of video data, such as video fields, “video slices”, and/or portions of macroblocks. It should thus be noted that the matter contained in the above description or shown in the accompanying drawings should be interpreted as illustrative and not a limiting sense.

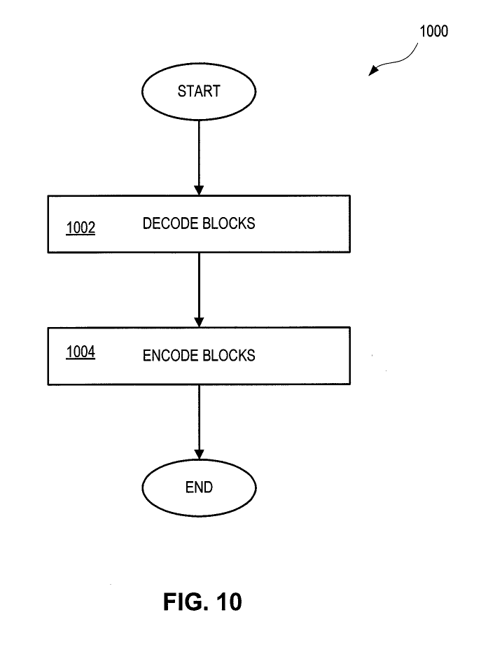

FIG. 10 shows one method 1000 for encoding a new unit of video data. Method 1000 begins with a step 1002 of incrementally decoding, in raster order, blocks within a search window of a unit of encoded reference video data into a reference window buffer. An example of step 1002 is decoding macroblocks within a search window of a reference I-Frame in bitstream buffer 350 into reference window buffer 388 using entropy decoder 382, IDCT/InvQ module 383, and intra prediction module 384 (FIG. 3). Another example of step 1002 is decoding macroblocks within a search window of a reference P′-Frame in bitstream buffer 750 into reference window buffer 798 using entropy decoders 782 and 792, IDCT/InvQ modules 783 and 793, intra prediction module 784, and ME/MC module 795 (FIG. 7).

Method 1000 proceeds to a step 1004 of encoding, in raster order, each block of the new video data based upon a decoded block of the reference window buffer. An example of step 1004 is encoding a macroblock 310 using ME/MC module 315, mux 320, DCT/Q module 335, and entropy encoder 345 based on a decoded macroblock in reference window buffer 388 (FIG. 3). Another example of step 1004 is encoding a macroblock 710 using ME/MC module 715, mux 720, DCT/Q module 735, and entropy encoder 745 based on a decoded macroblock in reference window buffer 798 (FIG. 7).

The changes described above, and others, may be made in the image sensor system described herein without departing from the scope hereof. It should thus be noted that the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall there between.

What is claimed is:

1. A method for encoding a new unit of video data, comprising the steps of:
incrementally, in raster order, decoding blocks within a search window of a unit of encoded reference video data into a reference window buffer; and
encoding, in raster order, each block of the new unit of video data based upon a decoded block of the reference window buffer.

2. The method of claim 1, wherein the reference window buffer is smaller than the unit of encoded reference video data.

3. The method of claim 2, wherein encoding of the new unit of video data starts after decoding the unit of encoded reference video data and encoding of the new unit of video data finishes after decoding the unit of encoded reference video data.

4. The method of claim 3, wherein:
the new unit of video data is a new frame of video data; and
the unit of encoded reference video data is an encoded reference frame of video data.

5. The method of claim 4, wherein each block is a macroblock.

6. The method of claim 1, wherein the reference window buffer is cyclic.

7. The method of claim 1, wherein the position of the search window is based upon the block of the new unit of video data being encoded.

8. The method of claim 7, wherein a central position of the search window corresponds to the position of the block of the new unit of video data being encoded.

9. The method of claim 7, further comprising discarding decoded blocks from the reference window buffer that do not have a corresponding encoded block within the search window.

10. The method of claim 1, wherein the search window is smaller than the unit of encoded reference video data.

11. The method of claim 1, wherein the step of encoding is performed in accordance with an H.264 video coding standard.

12. The method of claim 11, wherein the blocks within the search window of the unit of encoded reference video data comprise intra-coded blocks.

13. The method of claim 12, wherein the intra-coded blocks belong to an I-Frame of encoded reference video data.

14. The method of claim 12, wherein the blocks within the search window of the unit of encoded reference video data further comprise inter-coded blocks.

15. The method of claim 14, wherein the step of decoding comprises:
decoding the intra-coded blocks into a plurality of first blocks; and
using the first blocks, decoding the inter-coded blocks into decoded blocks in the reference window buffer.

16. The method of claim 15, wherein:
the intra-coded blocks belong to an I-Frame of encoded reference video data; and
the inter-coded blocks belong to a P-Frame of encoded reference video data that references the I-Frame of encoded reference video data.

17. A system for encoding a new unit of video data, comprising:
a reference window buffer;
a decoding subsystem configured to incrementally decode, in raster order, blocks within a search window of a unit of encoded reference video data into the reference window buffer; and
an encoding subsystem configured to encode, in raster order, each block of the new unit of video data based upon a decoded block of the reference window buffer.

18. The system of claim 17, wherein the reference window buffer is smaller than the unit of encoded reference video data.

19. The system of claim 18, wherein the encoding subsystem is configured to encode each block of the new unit of video data according to an H.264 video coding standard.

20. The system of claim 17, wherein the reference window buffer, the decoding subsystem, and the encoding subsystem are part of a common integrated circuit chip.
